(19) United States
(12) Patent Application Publication
(10) Pub. No.: US 2020/0318664 A1
(43) Pub. Date: Oct. 8, 2020

(54) ERGONOMIC THERMOSTATIC EXPANSION VALVE BULB CLAMP

(71) Applicant: Carrier Corporation, Palm Beach Gardens, FL (US)

(72) Inventors: Mark W. Shoemaker, Brownsburg (IN); James Amick, Coatsville, IN (US); Parmesh Verma, South Windsor, CT (US); Yinshan Feng, Manchester, CT (US)

(21) Appl. No.: 16/652,280

(22) PCT Filed: Sep. 28, 2018
(86) PCT No.: PCT/US2018/053421

§ 371 Date: Mar. 30, 2020

Related U.S. Application Data
(60) Provisional application No. 62/565,487, filed on Sep. 29, 2017.

(51) Int. Cl. F16B 2/24; F25B 41/06; F16B 7/04

(52) U.S. Cl. CPC F16B 2/245; F25B 41/067; F25B 2700/21175; F25B 2341/0661; F25B 2341/062; F16B 7/0433

(57) ABSTRACT

A clamp (204) for securing an expansion valve (XV) bulb (114) to a vapor header in a refrigeration system is provided. Aspects includes an arcuate member (210) having a first clamping portion (206) and a second clamping portion (208) extending therefrom and a terminal end of the first clamping portion having a first flange (212) and a terminal end of the second clamping portion having a second flange (214). The first clamping portion (206) and the second clamping portion (208) are configured to envelope the expansion valve (XV) bulb (114) and a vapor header in a refrigeration system.

### BACKGROUND

Exemplary embodiments pertain to the art of air conditioning systems or refrigeration systems and more particularly to an ergonomic thermostatic expansion valve bulb clamp.

Placement of a Thermostatic Expansion Valve (TXV or TEV) bulb or other temperature sensors on the outlet of an evaporator in a refrigeration system requires an understanding of the mechanics involved in the refrigeration system as a whole. Often, manufacturers of refrigeration systems do not have engineers or technicians applying a TXV bulb during initial assembly at a manufacturing plant. Because, non-engineers and non-technicians are installing these TXV bulbs or other pressure sensors, issues arise with inconsistent installation of the bulbs and with bulbs not making proper contact to the outlet of the evaporator. Typically, most manufacturers use a hose clamp type of connection resulting in a small area of contact to hold the bulb or temperature sensor on to the outlet of the evaporator in a refrigeration system. This can lead to the temperature sensor or bulb shifting during transit and/or the bulb not fully seating to the outlet of the evaporator. A solution is needed for a quick, easy, and accurate way to apply a TXV bulb in a refrigeration system.

### BRIEF DESCRIPTION

According to one embodiment, a clamp for securing an expansion valve (XV) bulb to a vapor header in a refrigeration system is provided. The clamp includes an arcuate member having a first clamping portion and a second clamping portion extending therefrom and a terminal end of the first clamping portion having a first flange and a terminal end of the second clamping portion having a second flange. The first clamping portion and the second clamping portion are configured to envelope the expansion valve (XV) bulb and a vapor header in a refrigeration system.

In addition to the one or more features described above, or as an alternative, further embodiments of the clamp may include that the expansion valve is thermostatic expansion valve (TXV).

In addition to the one or more features described above, or as an alternative, further embodiments of the clamp may include that the first flange and the second flange are separated by a first distance in a normal state and the first flange and the second flange are separated by a second distance in a deformed state and the second distance is less than the first distance.

In addition to the one or more features described above, or as an alternative, further embodiments of the clamp may include an inner sidewall and an exterior sidewall, wherein an insulating material is affixed to at least one of the inner sidewall and the exterior sidewall.

In addition to the one or more features described above, or as an alternative, further embodiments of the clamp may include that the clamp is a semi-rigid body

In addition to the one or more features described above, or as an alternative, further embodiments of the clamp may include that a length of the first clamping portion is substantially equal to a length of the second clamping portion and a distance between the first clamping portion the second clamping portion are substantially equal to a diameter of the TXV bulb.

In addition to the one or more features described above, or as an alternative, further embodiments of the clamp may include that the first clamping portion includes a first notched portion, and wherein the second claiming portion includes a second notched portion.

According to one embodiment, an evaporator assembly is provided. The evaporator assembly includes one or more evaporator coils including an outlet header, each of the one or more evaporator coils includes a plurality of circuits and an expansion valve operably coupled to the one or more evaporator coils, wherein the expansion valve is operable to control a flow of a refrigerant into a plurality of capillary tubes. The plurality of capillary tubes are operable to carry the refrigerant to the plurality of circuits. Operably coupled to the expansion valve is a temperature sensing bulb. The evaporator assembly includes a clamp configured to secure the temperature sensing bulb to the outlet header.

In addition to the one or more features described above, or as an alternative, further embodiments of the evaporator assembly may include that the clamp comprises: an arcuate member having a first clamping portion and a second clamping portion extending therefrom and a terminal end of the first clamping portion having a first flange and a terminal end of the second clamping portion having a second flange.

In addition to the one or more features described above, or as an alternative, further embodiments of the evaporator assembly may include that the expansion valve is thermostatic expansion valve (TXV).

In addition to the one or more features described above, or as an alternative, further embodiments of the evaporator assembly may include that the first flange and the second flange are separated by a first distance in a normal state and the first flange and the second flange are separated by a second distance in a deformed state and the second distance is less than the first distance.

In addition to the one or more features described above, or as an alternative, further embodiments of the evaporator assembly may include that the clamp further comprises: an inner sidewall and an exterior sidewall, wherein an insulating material is affixed to at least one of the inner sidewall and the exterior sidewall.

In addition to the one or more features described above, or as an alternative, further embodiments of the evaporator assembly may include that the clamp is a semi-rigid body

In addition to the one or more features described above, or as an alternative, further embodiments of the evaporator assembly may include that a length of the first clamping portion is substantially equal to a length of the second clamping portion and a distance between the first clamping portion the second clamping portion are substantially equal to a diameter of the TXV bulb.

In addition to the one or more features described above, or as an alternative, further embodiments of the evaporator assembly may include that the first clamping portion includes a first notched portion, and wherein the second clamping portion includes a second notched portion.

### BRIEF DESCRIPTION OF THE DRAWINGS

The following descriptions should not be considered limiting in any way. With reference to the accompanying drawings, like elements are numbered alike:

FIG. 1 is a block diagram of a vapor compression refrigeration system according to an embodiment of the present disclosure.

FIG. 2 depicts a diagram of a side view of a clamp for securing a TXV bulb to a vapor header according to one or more embodiments of the present disclosure;

FIG. 3 depicts a side view of another embodiment of a clamp for securing a TXV bulb to a vapor header according to one or more embodiments of the present disclosure;

FIG. 4 depicts a side view of another embodiment of the clamp for securing a TXV bulb to a vapor header according to one or more embodiments of the present disclosure; and

FIG. 5 depicts an evaporator assembly according to one or more embodiments of the present disclosure.

### DETAILED DESCRIPTION

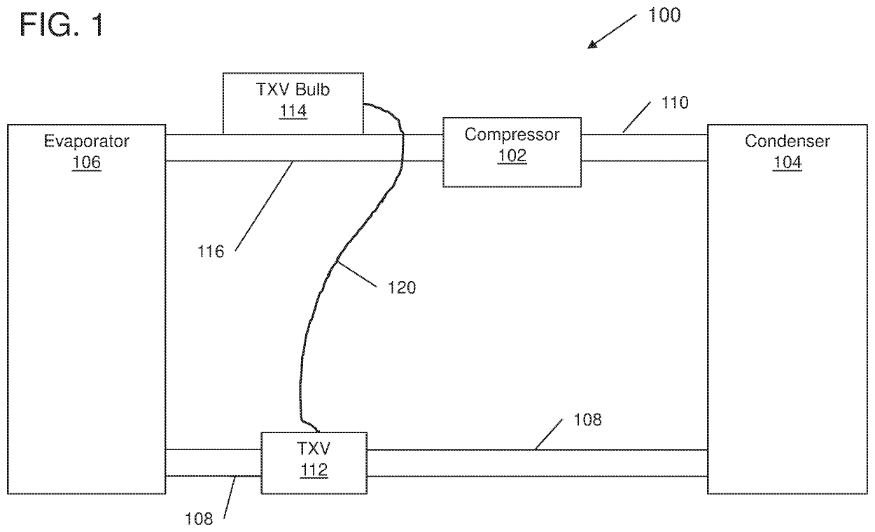

FIG. 1 depicts a block diagram of a vapor compression refrigeration system according to an embodiment of the present disclosure. The vapor compression refrigeration system 100 includes a compressor 102, a condenser 104, an evaporator 106, and a thermostatic expansion valve (TXV) 112 in fluid communication with one another via a first conduit 108, a second conduit 110, and a third conduit 116 (e.g., vapor header). While in the illustrative example, a conventional TXV is depicted, in one or more embodiments, the TXV can be an improved/modified/derived TXV that requires some type of temperature and/or pressure feedback from the outlet of the evaporator in order to control the pressure reduction in the expansion valve.

In the vapor compression refrigeration system 100, the compressor 102 operates to compress liquid refrigerant into a hot, high pressure gas and deliver it to the condenser 104 through the second conduit 110. The condenser 104 operates to cool the refrigerant gas into a high pressure liquid refrigerant by pulling air across the condenser. The high pressure, liquid refrigerant flows through the TXV 112 via the first conduit 108. The TXV 112 operates to reduce the pressure and the temperature of the liquid refrigerant before it enters the evaporator 106. The low pressure, low temperature liquid refrigerant flows through the evaporator 106 where it is converted to a low pressure, low temperature fluid (mostly gas) as air is blown across the evaporator to deliver cooled air to a space. The low pressure, low temperature fluid is then returned to the compressor 102 through the third conduit 116. It should be noted that the refrigeration system 100 depicted is for illustrative purposes showing a vapor compression based refrigeration cycle. In one or more embodiments, other variations in the refrigeration cycle with the four components (compressor, condenser or gas-cooler, evaporator and expansion valve) can be utilized. These other components could be, for example, accumulator, receiver, filter/drier, work recovery devices, multiples of heat exchangers, expansion valves or compressors etc.

The TXV 112 controls the amount of refrigerant entering the evaporator 106 by use of a temperature sensing bulb 114 affixed to the third conduit 116 (i.e. evaporator exit header). The temperature sensing bulb 114 is typically partially filled with a similar medium within the vapor compression refrigeration system 100 (i.e., liquid refrigerant), and is operably coupled to the TXV 112 via a capillary tube 120. The temperature sensing bulb 114 is configured to measure the temperature of the low pressure, low temperature fluid refrigerant through thermal contact with the third conduit 116 as refrigerant gas exits the evaporator 106. Typically, the temperature sensing bulb 114 causes the TXV 112 to open and close against a spring pressure within the valve body as the pressure in the temperature sensing bulb 114 increases and decreases as a result of rise and fall of temperature. For example, as the temperature of the refrigerant gas exiting the evaporator 106 decreases, the pressure in the bulb 114 also decreases and therefore the spring counter force increases and causes the TXV 112 to have a narrower opening.

Proper installation, including placement and a clamping force, of the temperature sensing bulb 114 on the third conduit 116 attached to the evaporator 106 is important for achieving optimal performance of the TXV 112. In addition to the clamping force, insulation of the temperature sensing bulb 114 reduces the risk of environmental factors affecting the temperature sensing bulb 114 performance. Environmental factors include the conditioned air and moisture from the air affecting the TXV operation due to the bulb temperature being influenced from this air and/or moisture resulting in an inaccurate temperature sensing of the outlet of the evaporator. Current methods and technologies for attaching the temperature sensing bulb 114 to the third conduit 116 have a wide variation of performance. The variation of performance can result from the TXV bulb not making good contact with the outlet of the evaporator and causing erratic operation of the TXV. There exists a need for a simplified apparatus and method for attaching TXV bulbs 114 for better and more consistent performance.

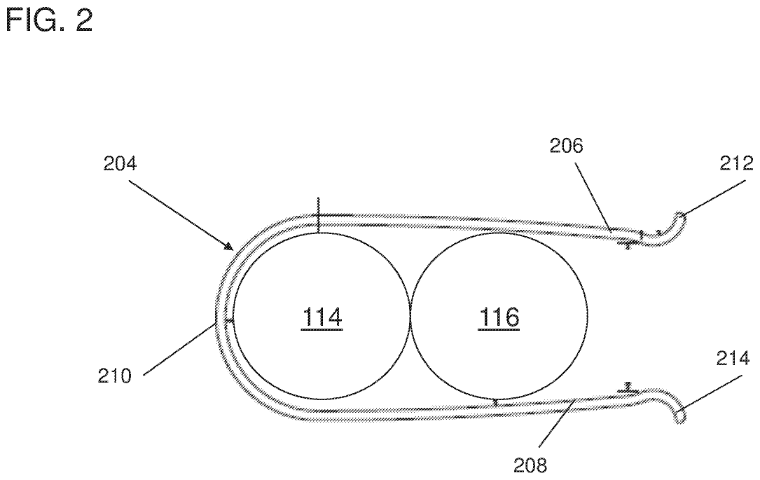

In one or more embodiments, an ergonomic thermostatic expansion valve bulb clamp 204 is provided. FIG. 2 depicts a diagram of a side view of a clamp for securing a TXV bulb to a vapor header according to one or more embodiments of the present disclosure. The diagram includes a temperature sensing bulb 114, third conduit 116, and clamp 204. The clamp 204 is operable to secure the temperature sensing bulb 114 to the third conduit 116 within a refrigeration system. The clamp 204 includes a first clamping portion 206 and a second clamping portion 208 that extend from an arcuate member 210. The clamp 204 is a semi-rigid body and the terminal ends of the first clamping portion 206 and the second clamping portion 208 are not attached and are moveable toward and away from one another starting at a predetermined open position. When the predetermined open position has a distance equal to a predetermined distance, this can be referred to as the natural state of the semi-rigid clamp 204. The opening between the terminal ends of the first clamping portion 206 and second clamping portion 208 can be increased or decreased with an application of force to the first clamping portion 206 and second clamping portion 208. When the distance between the terminal end of the first clamping portion 206 and the terminal end of the second clamping portion 208 are not equal to the predetermined distance, the clamp is in a deformed state. After the application of force is removed, the opening returns to the predetermined open position.

In one or more embodiments, the terminal ends of the first clamping portion 206 and second clamping portion 208 have a first flange 212 and a second flange 214, respectively. The first flange 212 and the second flange 214 can be used to manipulate the first clamping portion 206 and second clamping portion 208 to engage and/or release the clamp 204 to and/or from a temperature sensing bulb 114. In one or more embodiments, the predetermined open position has a distance that is less than the largest diameter between the temperature sensing bulb 114 and the third conduit 116.

In one or more embodiments of the present disclosure, the clamp 204 can comprise a material. This material can be a metal, plastic, or a combination of metal and plastic.

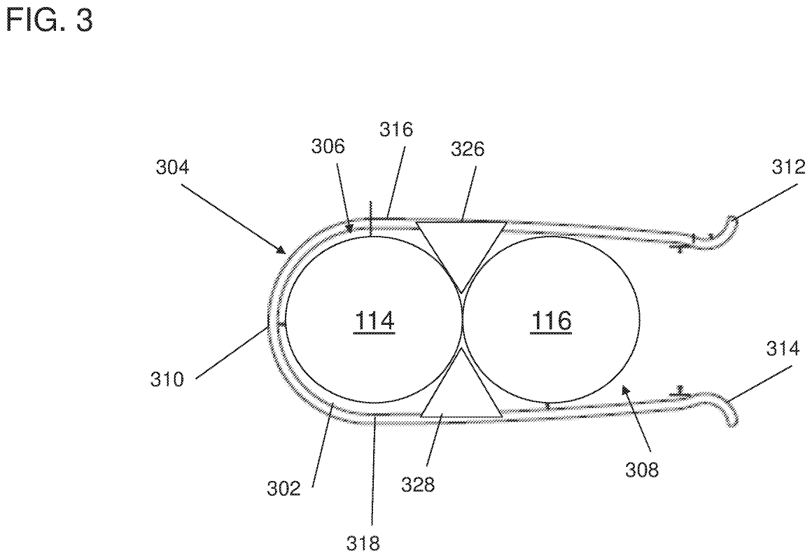

FIG. 3 depicts a side view of another embodiments of a clamp for securing a TXV bulb to a vapor header according to one or more embodiments of the present disclosure. The clamp 304 is depicted as engaged to the temperature sensing bulb 114 and the third conduit 116 in the illustrated example. The clamp 304 includes a housing 310 including an inner wall 302, a first portion 306, and a second portion 308. The first portion 306 has a first diameter and is configured to receive the temperature sensing bulb 114. The second portion has a second diameter and is configured to receive the third conduit 116. The first portion 306 is formed by a first clamping portion 316 of the housing 310 and a second clamping portion 318 of the housing 310. The first clamping portion 316 includes a first notched portion 326 protruding in an inward direction of the housing 310. The second clamping portion 318 includes a second notched portion 328 protruding in an inward direction of the housing 310.

The first notched portion 326 and the second notched portion 328 are spaced to allow for the temperature sensing bulb 114 to fit between an arcuate section of the housing 310 and the first notched portion and second notched portion. The second portion 308 is configured to receive the third conduit 116. The housing 310 is semi-rigid and the terminal ends of the first clamping portion 316 and the second clamping portion 318 are not attached and are moveable toward and away from one another starting at a predetermined open position. When the predetermined open position has a distance equal to a predetermined distance, this can be referred to as the natural state of the semi-rigid clamp 304. The opening between the terminal ends of the first clamping portion 316 and second clamping portion 318 can be increased or decreased with an application of force to the first clamping portion 316 and second clamping portion 318. When the distance between the terminal end of the first clamping portion and the terminal end of the second clamping portion are not equal to the predetermined distance, the clamp is in a deformed state. After the application of force is removed, the opening returns to the predetermined open position.

In one or more embodiments, the terminal ends of the first clamping portion 316 and second clamping portion 318 have a first flange 312 and a second flange 314, respectively. The first flange 312 and the second flange 314 can be used to manipulate the first clamping portion 316 and second clamping portion 318 to engage and/or release the clamp 304 to and/or from a temperature sensing bulb 114 and the like. In one or more embodiments, the predetermined open position has a distance that is less than the diameter of the temperature sensing bulb 114 and the third conduit 116.

In one or more embodiments, the notched portions 326 and 328 can be stops latterly across the clamp to stop a TXV bulb from slipping out when the clamp is engaged to the TXV bulb and the conduit during installation. The notched portions can be on both ends or on only on end of the clamp.

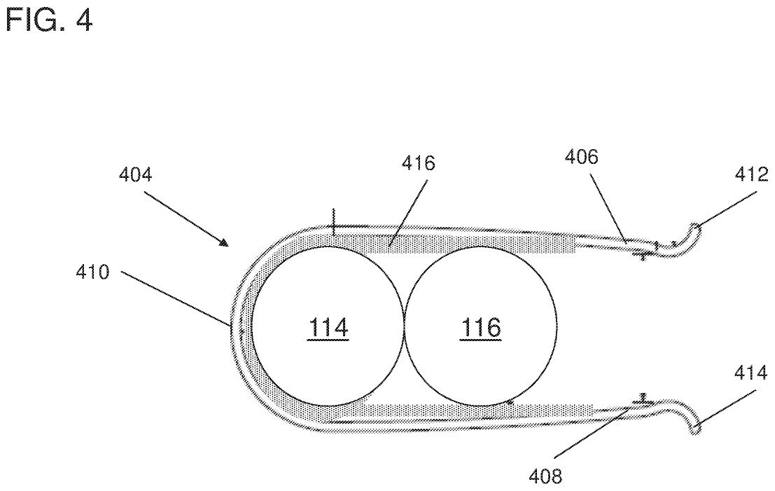

FIG. 4 depicts a side view of another embodiment of the clamp for securing a TXV bulb to a vapor header according to one or more embodiments of the present disclosure. The clamp 404 is depicted as engaged to the temperature sensing bulb 114 and the third conduit 116 in the illustrated example. The clamp 404 includes a first clamping portion 406 and second clamping portion 408 that extend out from an arcuate member 410 of the clamp 404. The arcuate member 410 includes an inner sidewall. The inner sidewall of the clamp 404 partially defines an ellipse. The inner sidewall envelopes at least a portion of the temperature sensing bulb 114. Along this inner sidewall, the clamp 404 includes an insulating material 416. The insulating material 416 can be any material operable to insulate the temperature sensing bulb 114 including but not limited to thermal insulation.

In another embodiment, an insulating material can be attached to the exterior of the clamp 404. The insulation and clamp can be provided into one (1) piece that can be easily installed. The clamp, in one or more embodiments, can be formed from a spring steel alloy and is formed such that the temperature sensing bulb 114 slides into the clamp and then attached to the third conduit 116.

In one or more embodiments, the insulating material can be affixed to the exterior of the clamp and can cover the ends of a TXV bulb. The insulation can be affixed to the clamp using adhesive that is applied to a foam prior to be installed on to the clamp.

In one or more embodiments, the clamp is formed such that the temperature sensing bulb 114 can only be installed in a depression that exists on the vapor header for the temperature sensing bulb. Technical benefits for this design include the prevention of installation that results in poor bulb and tube contact.

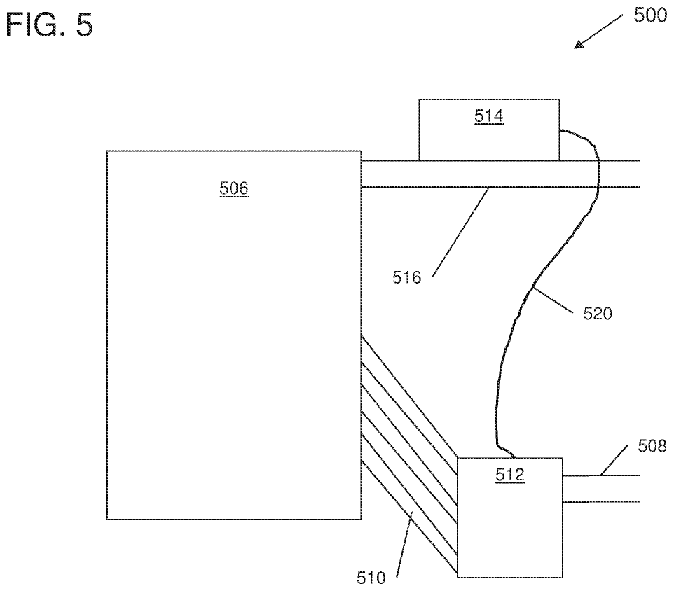

FIG. 5 depicts an evaporator assembly 500 according to one or more embodiments of the present disclosure. The evaporator assembly 500 includes an evaporator 506, metering device 512, a first conduit 508, a second conduit 516, evaporator capillary tubes 510, a temperature sensing bulb 514, and a bulb capillary line 520. The evaporator 506 can be coupled to one or more evaporator capillary tubes which carry refrigerant to various circuits in the evaporator coils. The first conduit 508 is a line coming from a condenser. The first conduit 508 carries refrigerant to the metering device 512. The outlet of the metering device 512 connects to the one or more capillary tubes 510. In one or more embodiments, the metering device 512 includes a thermostatic expansion valve (TXV). The outlet of the evaporator 506 is coupled to the second conduit 516. The temperature sensing bulb 514 is arranged on the second conduit 516. The temperature sensing bulb 514 is coupled to the metering device 512 through the bulb capillary line 520.

A detailed description of one or more embodiments of the disclosed apparatus are presented herein by way of exemplification and not limitation with reference to the Figures.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A clamp for securing an expansion valve (XV) bulb to a vapor header in a refrigeration system, the clamp comprising:
an arcuate member having a first clamping portion and a second clamping portion extending therefrom;
a terminal end of the first clamping portion having a first flange and a terminal end of the second clamping portion having a second flange; and
wherein the first clamping portion and the second clamping portion are configured to envelope the expansion valve (XV) bulb and a vapor header in a refrigeration system.

2. The expansion valve of claim 1, wherein the expansion valve is thermostatic expansion valve (TXV).

3. The clamp of claim 1,
wherein the first flange and the second flange are separated by a first distance in a normal state;
wherein the first flange and the second flange are separated by a second distance in a deformed state; and
wherein the second distance is less than the first distance.

4. The clamp of claim 3, further comprising an inner sidewall and an exterior sidewall, wherein an insulating material is affixed to at least one of the inner sidewall and the exterior sidewall.

5. The clamp of claim 1, wherein the clamp is a semi-rigid body.

6. The clamp of claim 1, wherein a length of the first clamping portion is substantially equal to a length of the second clamping portion; and
wherein a distance between the first clamping portion the second clamping portion are substantially equal to a diameter of the TXV bulb.

7. The clamp of claim 1, wherein the first clamping portion includes a first notched portion, and wherein the second clamping portion includes a second notched portion.

8. An evaporator assembly comprising:
one or more evaporator coils including an outlet header, each of the one or more evaporator coils includes a plurality of circuits;
an expansion valve operably coupled to the one or more evaporator coils, wherein the expansion valve is operable to control a flow of a refrigerant into a plurality of capillary tubes;
wherein the plurality of capillary tubes are operable to carry the refrigerant to the plurality of circuits;
a temperature sensing bulb, operably coupled to the expansion valve; and
a clamp configured to secure the temperature sensing bulb to the outlet header.

9. The evaporator assembly of claim 8, wherein the clamp comprises:
an arcuate member having a first clamping portion and a second clamping portion extending therefrom; and
a terminal end of the first clamping portion having a first flange and a terminal end of the second clamping portion having a second flange.

10. The evaporator assembly of claim 8, wherein the expansion valve is thermostatic expansion valve (TXV).

11. The evaporator assembly of claim 9, wherein the first flange and the second flange are separated by a first distance in a normal state;
wherein the first flange and the second flange are separated by a second distance in a deformed state; and
wherein the second distance is less than the first distance.

12. The evaporator assembly of claim 9, wherein the clamp further comprises an inner sidewall and an exterior sidewall, wherein an insulating material is affixed to at least one of the inner sidewall and the exterior sidewall.

13. The evaporator assembly of claim 9, wherein the clamp is a semi-rigid body.

14. The evaporator assembly of claim 9, wherein a length of the first clamping portion is substantially equal to a length of the second clamping portion; and
wherein a distance between the first clamping portion the second clamping portion are substantially equal to a diameter of the TXV bulb.

15. The evaporator assembly of claim 9, wherein the first clamping portion includes a first notched portion, and wherein the second clamping portion includes a second notched portion.
